(19) United States
(12) Patent Application Publication
(10) Pub. No.: US 2010/0232309 A1
(43) Pub. Date: Sep. 16, 2010

(54) METHODS AND SYSTEMS FOR DYNAMIC CALL BLOCKING IN WIMAX IDLE MODE

(75) Inventors: Guangming Carl Shi, San Diego, CA (US); Tom Chin, San Diego, CA (US); Ta-yan Siu, San Diego, CA (US); Steven D. Cheng, San Diego, CA (US); Shan Qing, San Diego, CA (US); Kuo-Chun Lee, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/706,400

(22) Filed: Feb. 16, 2010

Related U.S. Application Data
(60) Provisional application No. 61/160,275, filed on Mar. 13, 2009.

(51) Int. Cl. H04L 12/26

(52) U.S. Cl. 370/252

(57) ABSTRACT

Certain embodiments of the present disclosure present methods and apparatuses that enable a mobile station (MS) to selectively reject downlink (DL) data during idle mode. The MS may determine whether to reject the pending DL data based on information about the data. This information may be provided by a base station (BS) that is part of the access service network (ASN) that is retaining the DL data. The information provided by the BS may, for instance, include service flow information related to the pending DL data. In certain embodiments, the information may include one or more internet protocol (IP) packets that are part of the pending DL data.

### CLAIM OF PRIORITY

This application claims the benefit of priority from U.S. Provisional Patent Application Ser. No. 61/160,275, entitled “Method of Dynamic Call Blocking in WiMAX Idle Mode” and filed Mar. 13, 2009, which is assigned to the assignee of this application and is fully incorporated herein by reference for all purposes.

### TECHNICAL FIELD

Certain embodiments of the present disclosure generally relate to wireless communication and, more particularly, to dynamic call blocking in idle mode when utilizing the Worldwide Interoperability for Microwave Access (WiMAX) standard.

### BACKGROUND

Orthogonal frequency-division multiplexing (OFDM) and orthogonal frequency division multiple access (OFDMA) wireless communication systems, such as those compliant with the IEEE 802.16 family of standards, typically use a network of base stations to communicate with wireless devices (i.e., mobile stations) registered for services in the systems based on the orthogonality of frequencies of multiple subcarriers and can be implemented to achieve a number of technical advantages for wideband wireless communications, such as resistance to multipath fading and interference. Each base station (BS) emits and receives radio frequency (RF) signals that convey data to and from the mobile stations (MS).

When an MS is in idle mode, the MS may listen to a Paging Advertisement (MOB_PAG-ADV) message in an effort to be notified of pending downlink (DL) data. A BS may broadcast the MOB_PAG-ADV message when an Access Service Network (ASN) comprising the BS receives incoming data. According to the current Worldwide Interoperability for Microwave Access (WiMAX) standards, the MS may reply to the pending DL data by utilizing a network entry procedure. If the BS does not receive a response from the MS within a certain amount of time, the BS may retry sending the MOB_PAG-ADV message to the MS. After a few failed retries, the ASN may conclude that the MS is unreachable and therefore delete the data that was addressed to the MS.

### SUMMARY

Certain embodiments of the present disclosure provide a method for method for wireless communications. The method generally includes determining downlink (DL) data pending on a network addressed to a mobile station, generating a medium access control (MAC) message indicating information about the pending DL data, transmitting the MAC message to the mobile station, and receiving a notification about the pending DL data from the mobile station, wherein the notification indicates acceptance or rejection of the pending DL data.

Certain embodiments of the present disclosure provide a method for method for wireless communications. The method generally includes receiving a first medium access control (MAC) message comprising information about pending downlink (DL) data, determining whether to accept or reject the pending DL data based on the information indicated by the first MAC message, and transmitting a second MAC message to indicate the determination.

Certain embodiments of the present disclosure provide an apparatus for wireless communications. The apparatus generally includes means for determining downlink (DL) data pending on a network addressed to a mobile station, means for generating a medium access control (MAC) message indicating information about the pending DL data, means for transmitting the MAC message to the mobile station, and means for receiving a notification about the pending DL data from the mobile station, wherein the notification indicates acceptance or rejection of the pending DL data.

Certain embodiments of the present disclosure provide an apparatus for wireless communications. The apparatus generally includes means for receiving a first medium access control (MAC) message comprising information about pending downlink (DL) data, means for determining whether to accept or reject the pending DL data based on the information indicated by the first MAC message, and means for transmitting a second MAC message to indicate the determination.

Certain embodiments of the present disclosure provide an apparatus for wireless communications. The apparatus generally includes logic for determining downlink (DL) data pending on a network addressed to a mobile station, logic for generating a medium access control (MAC) message indicating information about the pending DL data, logic for transmitting the MAC message to the mobile station, and logic for receiving a notification about the pending DL data from the mobile station, wherein the notification indicates acceptance or rejection of the pending DL data.

Certain embodiments of the present disclosure provide an apparatus for wireless communications. The apparatus generally includes logic for receiving a first medium access control (MAC) message comprising information about pending downlink (DL) data, logic for determining whether to accept or reject the pending DL data based on the information indicated by the first MAC message, and logic for transmitting a second MAC message to indicate the determination.

Certain embodiments of the present disclosure provide a computer-program storage apparatus for wireless communications, comprising a memory device having instructions stored thereon, the instructions being executable by one or more processors. The instructions generally include instructions for determining downlink (DL) data pending on a network addressed to a mobile station, instructions for generating a medium access control (MAC) message indicating information about the pending DL data, instructions for transmitting the MAC message to the mobile station, and instructions for receiving a notification about the pending DL data from the mobile station, wherein the notification indicates acceptance or rejection of the pending DL data.

Certain embodiments of the present disclosure provide a computer-program storage apparatus for wireless communications, comprising a memory device having instructions stored thereon, the instructions being executable by one or more processors. The instructions generally include instructions for receiving a first medium access control (MAC) message comprising information about pending downlink (DL) data, instructions for determining whether to accept or reject the pending DL data based on the information indicated by the first MAC message, and instructions for transmitting a second MAC message to indicate the determination.

### BRIEF DESCRIPTION OF THE DRAWINGS

So that the manner in which the above-recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain embodiments of the present disclosure.

FIG. 2 illustrates various components that may be utilized in a wireless device in accordance with certain embodiments of the present disclosure.

FIG. 3 illustrates an example transmitter and an example receiver that may be used within a wireless communication system that utilizes orthogonal frequency-division multiplexing and orthogonal frequency division multiple access (OFDM/OFDMA) technology in accordance with certain embodiments of the present disclosure.

FIG. 4 illustrates example operations for selectively rejecting downlink (DL) data in idle mode, in accordance with certain embodiments of the present disclosure.

FIG. 4A is a block diagram of means corresponding to the example operations illustrated in FIG. 4.

FIG. 5 illustrates a proposed format for a Paging Advertisement (MOB_PAG-ADV) message, in accordance with certain embodiments of the present disclosure.

FIG. 6 illustrates a proposed format for a Ranging Request (RNG-REQ) message, in accordance with certain embodiments of the present disclosure.

FIG. 7 illustrates example message exchange between a mobile station and a base station for selectively rejecting DL data in idle mode, in accordance with certain embodiments of the present disclosure.

FIG. 8 illustrates example operations for an alternate approach in selectively rejecting DL data in idle mode, in accordance with certain embodiments of the present disclosure.

FIG. 8A is a block diagram of means corresponding to the example operations illustrated in FIG. 8.

FIG. 9 illustrates example message exchange for the alternate approach in selectively rejecting DL data in idle mode, in accordance with certain embodiments of the present disclosure.

### DETAILED DESCRIPTION

Certain embodiments are described herein with reference to the drawings, wherein like reference numerals are used to refer to like elements throughout. In the following description, for purposes of explanation, numerous specific details are set forth in order to provide a thorough understanding of certain embodiments. However, it may be that such embodiment(s) can be practiced without these specific details. In other instances, well-known structures and devices are shown in block diagram form in order to facilitate describing certain embodiments.

### Exemplary Wireless Communication System

The techniques described herein may be used for various broadband wireless communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

One example of a communication system based on an orthogonal multiplexing scheme is a WiMAX system. WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX is based on OFDM and OFDMA and offers the full mobility of cellular networks at broadband speeds.

IEEE 802.16x is an emerging standard organization to define an air interface for fixed and mobile broadband wireless access (BWA) systems. These standards define at least four different physical layers (PHYs) and one medium access control (MAC) layer. The OFDM and OFDMA physical layer of the four physical layers are the most popular in the fixed and mobile BWA areas respectively.

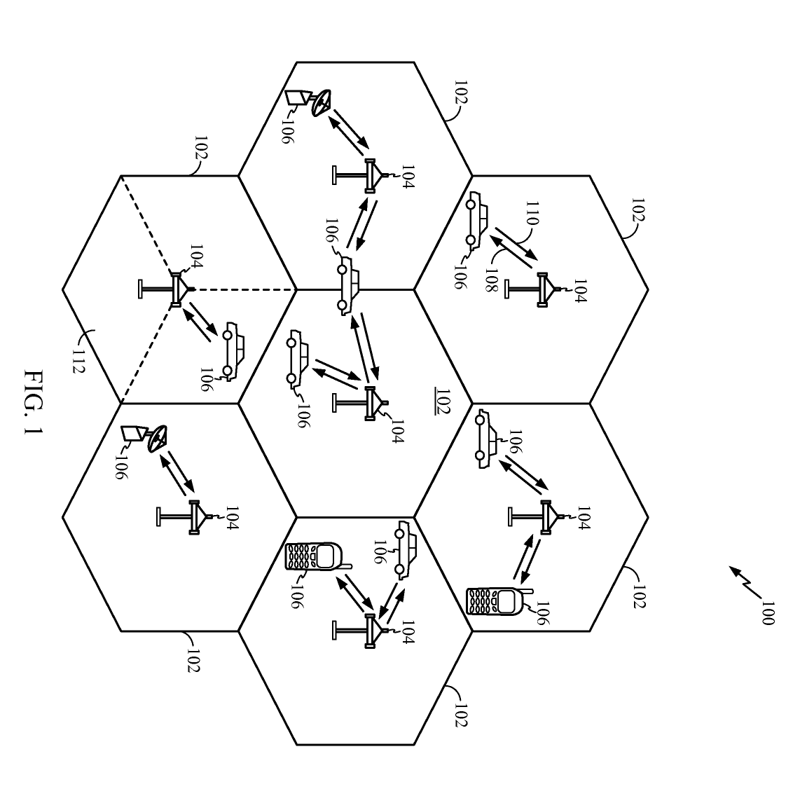

FIG. 1 illustrates an example of a wireless communication system 100. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers (PCs), etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

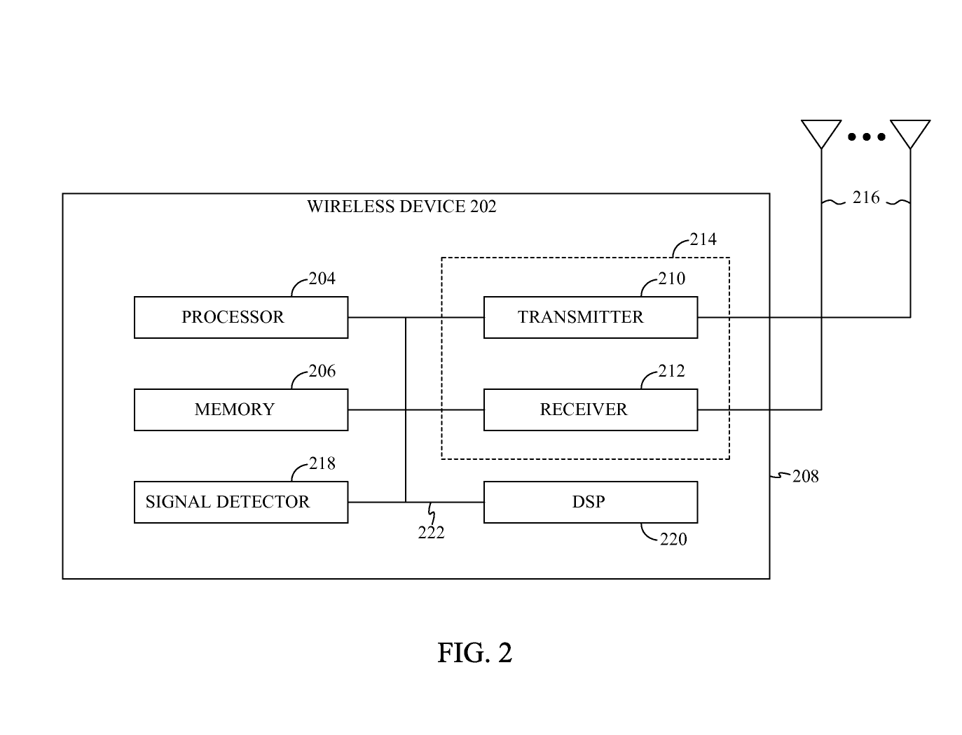

FIG. 2 illustrates various components that may be utilized in a wireless device 202. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy from pilot subcarriers or signal energy from the preamble symbol, power spectral density, and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

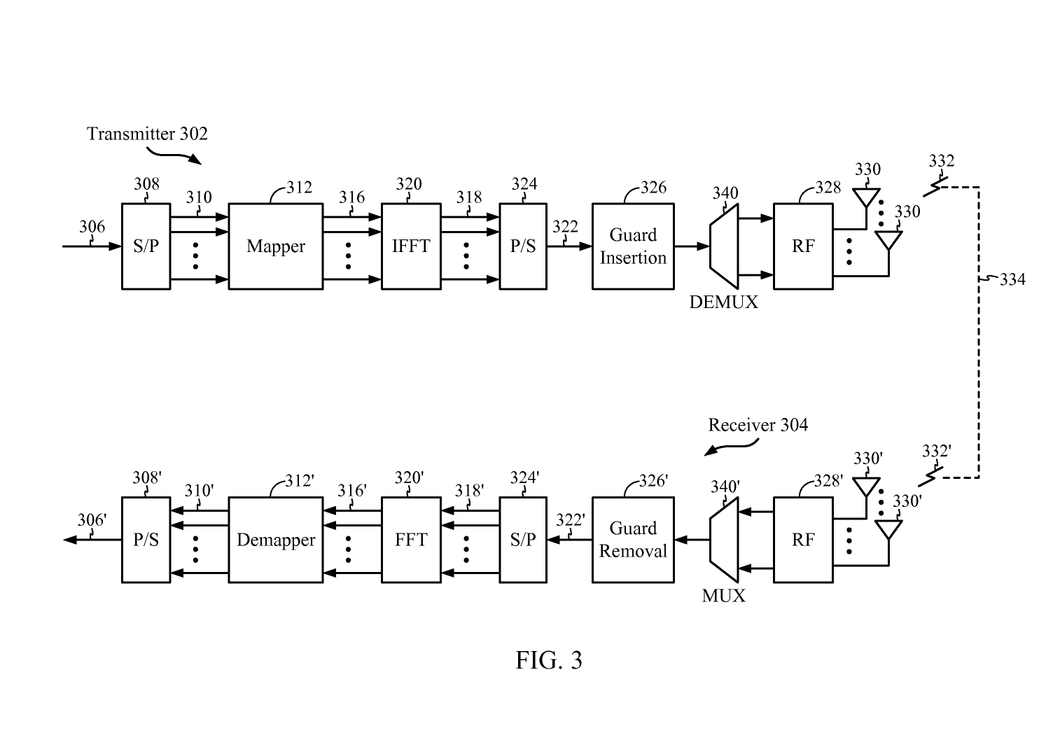

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Nₛ, is equal to N_{cp} (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless communication system 100 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312, thereby outputting N parallel data streams 310′. A P/S converter 308′ may combine the N parallel data streams 310′ into a single data stream 306′. Ideally, this data stream 306′ corresponds to the data 306 that was provided as input to the transmitter 302.

### Exemplary Dynamic Call Blocking in WiMAX Idle Mode

Certain embodiments of the present disclosure provide techniques that enables a mobile station (MS) to accept or reject downlink (DL) data during idle mode efficiently. The MS may determine whether to reject the pending DL data based on information received about the data. This information may be provided by a base station (BS) that is part of the Access Service Network (ASN) which is retaining the DL data.

The information provided by the BS may, for instance, include service flow information related to the pending DL data. In certain embodiments, the information may include one or more internet protocol (IP) packets that are part of the pending DL data. The techniques may allow higher layers at the MS and an Internet Server to exchange data in an effort to reject incoming data selectively without establishing a WiMAX service flow.

One way of accomplishing dynamic call blocking may be an MS performing a network entry procedure, but releasing a service flow involved after the service flow is restored. This approach may not be efficient since, by the time the service flow is released, processing may have already been incurred. In some cases, data transmission may have already started. Accordingly, techniques that may allow the MS to efficiently reject incoming data may be desirable.

In the current WiMAX standards, before entering an idle mode, the MS may choose whether or not to receive incoming data for a service flow to be retained. To achieve this, the MS may set a Paging Preference parameter. According to the WiMAX standards, the Paging Preference parameter is present in the Idle Mode Retain Information Type Length Value (TLV) of a Deregister Request (MOB_DREG-REQ) message.

The information regarding whether or not to receive incoming data should be known and provided to the BS in advance. However, in some cases, the MS may not be aware of the need to block the data before the DL data arrives. For example, a user or application may be busy performing other operations when the data arrives. Or, a multi-mode MS having a traffic connection with another network may not be able to set up a WiMAX service flow. Also, it might be desirable for a user or an application to receive the data selectively while in idle mode (e.g., receive important data but ignore other data).

Certain embodiments of the present disclosure provide techniques that may allow an MS to reject incoming data when the MS is in idle mode. Incoming data may be rejected without establishing a WiMAX service flow.

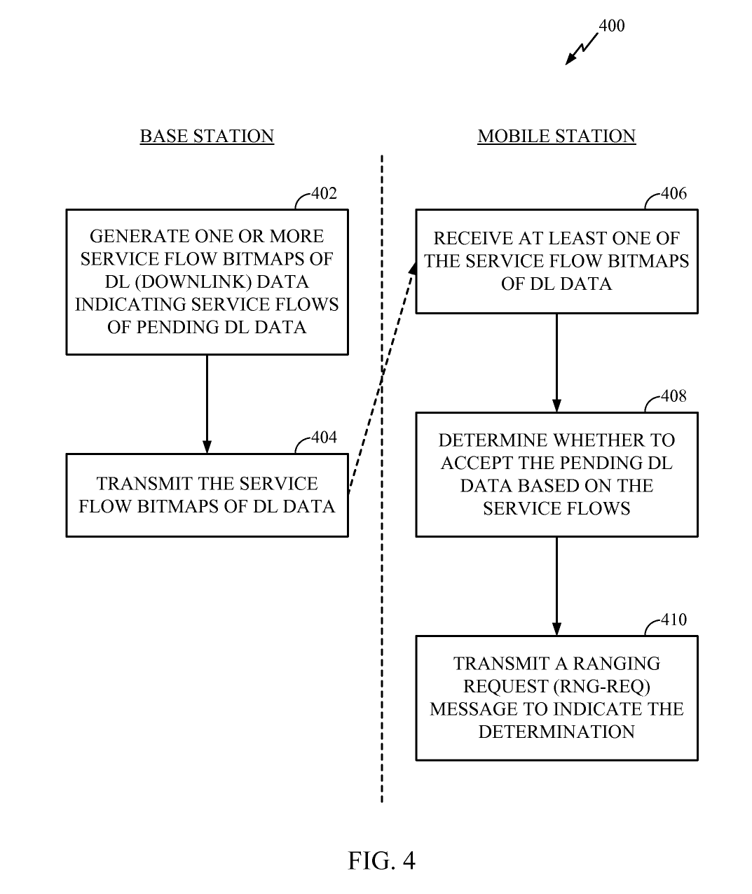

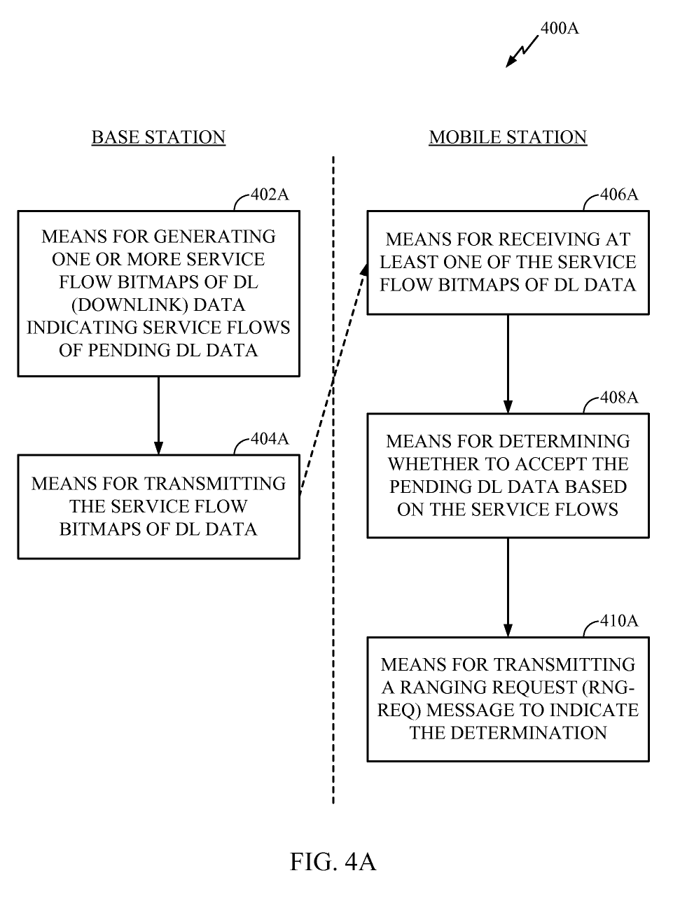

FIG. 4 illustrates example operations 400 for selectively rejecting DL data in idle mode, in accordance with certain embodiments of the present disclosure. As illustrated, operations 402-404 may be performed by a BS, while operations 406-410 may be performed by an MS.

At 402, the BS may generate one or more Service Flow Bitmaps of DL data indicating service flows of pending DL data. To obtain the service flow information, the BS may inspect the pending DL data. At 404, the BS may transmit the Service Flow Bitmaps of DL data to one or more MSs. To accomplish this, the BS may broadcast an enhanced MOB_PAG-ADV message. The MOB_PAG-ADV message may comprise one or more service flow bitmaps of the pending DL data. Each service flow bitmap may comprise one or more bits, and each of the bits may indicate whether or not the pending DL data is associated with one of the service flows.

At 406, an MS may receive at least one of the Service Flow Bitmaps of DL data. At 408, the MS may determine whether to accept the pending DL data directed to the MS, based on the service flow information contained in the bitmap. The service flow information in the bitmap may be used to identify application information related to the pending DL data. The application information may then be used to determine whether the pending DL data is to be accepted or rejected.

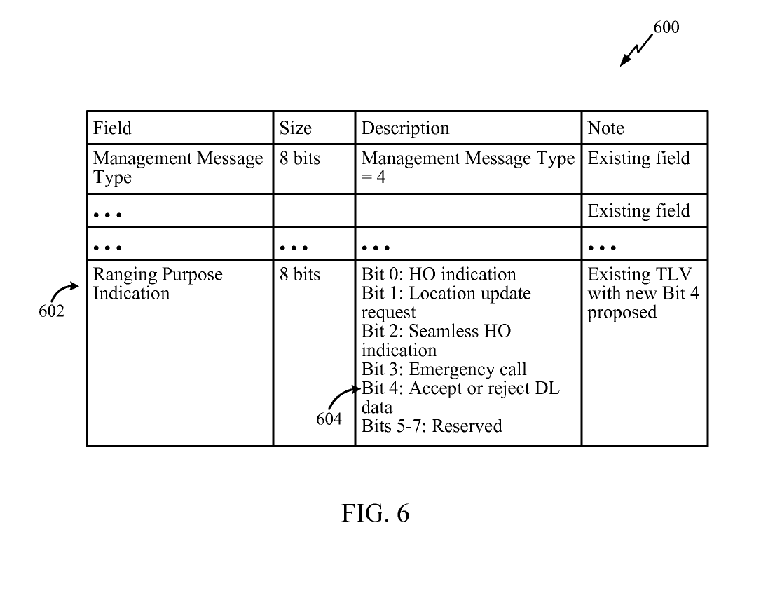

At 410, the MS may transmit a modified Ranging Request (RNG-REQ) message to indicate the determination. To accomplish this, an enhanced Ranging Purpose Indication TLV of the RNG-REQ message may be added to the RNG-REQ message as described in FIG. 6.

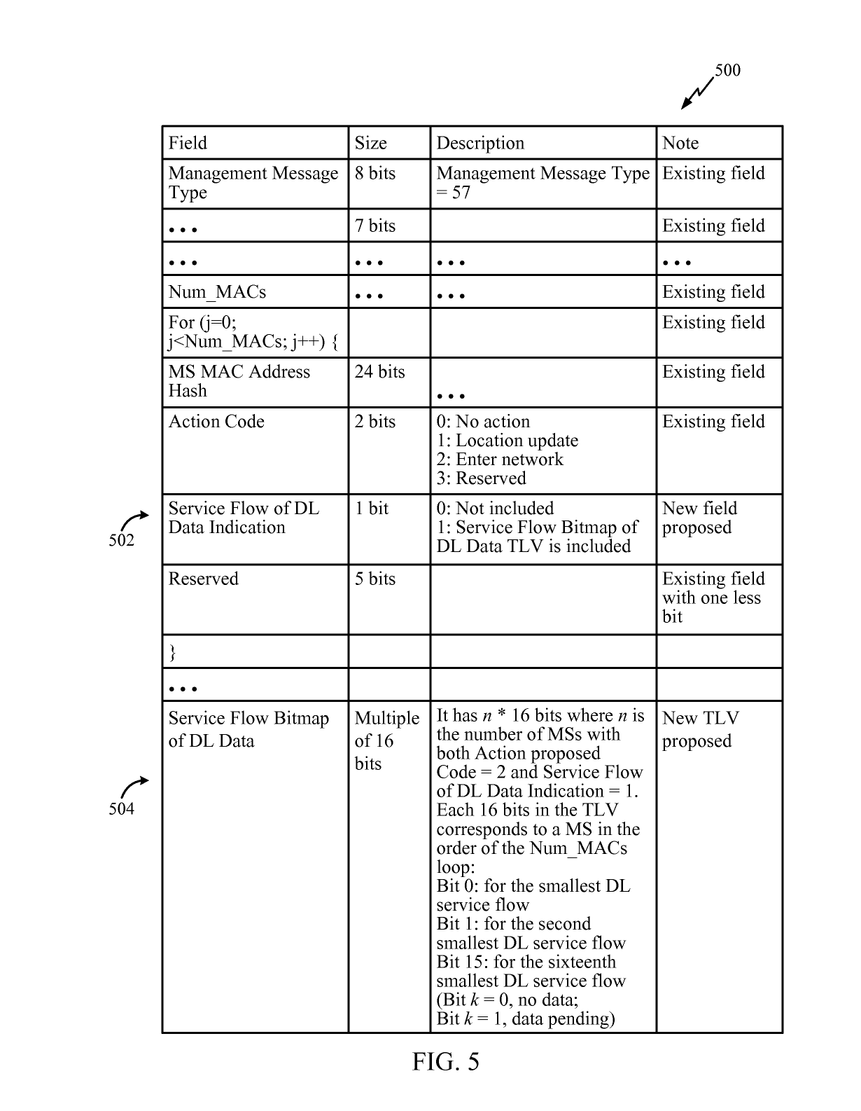

FIG. 5 illustrates a proposed format for a MOB_PAG-ADV message 500, in accordance with certain embodiments of the present disclosure. The MOB_PAG-ADV message may be used by a BS to transmit Service Flow Bitmaps of DL data to one or more MSs.

In addition to currently existing fields, the MOB_PAG-ADV message 500 may include a Service Flow of DL Data Indication field 502 and a Service Flow Bitmap of DL Data TLV 504. The Service Flow of DL Data Indication field 502 may be a one-bit flag that indicates presence of the Service Flow Bitmap of DL Data TLV 504. When set to “1,” the field 502 may indicate that the MOB_PAG-ADV message includes the TLV 504. When set to “0,” the field 502 may indicate that the TLV 504 is not included.

For certain embodiments, the Service Flow Bitmap of DL Data TLV 504 may include, for instance, n Service Flow Bitmaps for n mobile stations. Each bitmap may correspond to one of the MSs with Action Code=2 and Service Flow of DL Data Indication=1. The bitmaps may be included in the order of the MSs in the loop of Num_MACs of the MOB_PAG-ADV message 500. Each of the bitmaps may include 16 bits, each of which may correspond to a service flow in ascending service flow identification (ID) values, with “1” indicating DL data pending. According to certain embodiments of the present disclosure, a maximum of 16 service flows may be retained in idle mode.

When an MS receives the MOB_PAG-ADV message 500 with a match of its MS medium access control (MAC) address number, the MS may decode Service Flow Bitmap of DL Data if available. By looking into the bitmap, the MS identifies the service flows that have a corresponding pending DL data (e.g., service flows with a ‘1’ in their corresponding bit position in the bitmap).

For certain embodiment, higher layers at the MS may identify application information from the service flow ID and provide the application information through the man machine interface to a user or application to decide whether to accept or reject the pending data. In certain embodiments, the MS may autonomously reject the DL data without notifying the user or application. The MS may then indicate to the BS, acceptance or rejection of the pending DL data, via a modified RNG-REQ message 600 as illustrated in FIG. 6.

FIG. 6 illustrates a proposed format 600 for a Ranging Request (RNG-REQ) message, in accordance with certain embodiments of the present disclosure. The RNG-REQ message may include a Ranging Purpose Indication TLV 602. In addition to currently existing bits, the Ranging Purpose Indication TLV 602 may include a new bit 604, such as Bit 4, which may be used by the MS to indicate acceptance or rejection of the pending DL data. When set to “0,” the bit 604 may indicate acceptance of the pending DL data. When set to “1,” the bit 604 may indicate rejection of the pending DL data.

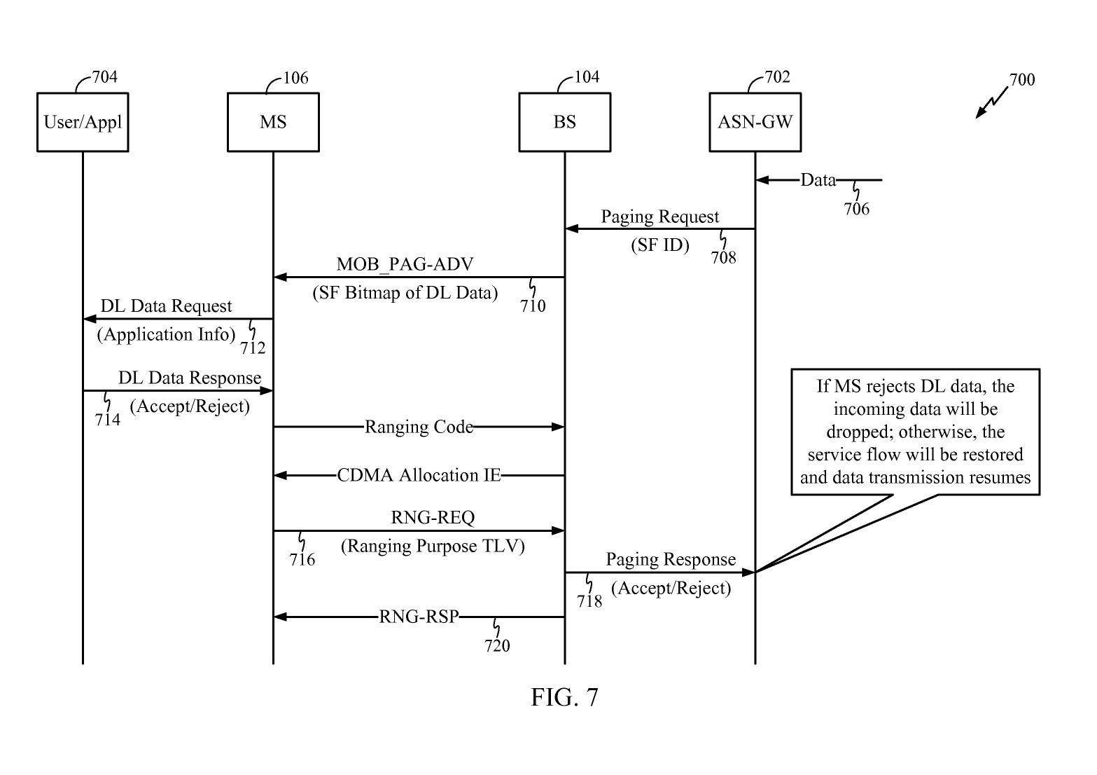

FIG. 7 illustrates an example exchange of messages for accepting or rejecting pending DL data. As illustrated, a BS 104 and an MS 106, as well as an Access Service Network Gateway (ASN-GW) 702 and a user/application 704 may communicate with each other.

The ASN-GW 702 may receive incoming data 706 and transmit a Paging Request 708 with information about the service flow ID (SF ID) to the BS 104. The SF ID information may be obtained from the received data.

The BS may transmit an SF Bitmap of DL data that is generated based on the SF ID information received from the ASN-GW. The BS may transmit the SF Bitmap of DL data via a MOB_PAG-ADV message 710 with a format illustrated in FIG. 5. The MS may decode the service flow bitmap and identify one or more service flows with DL data pending. The MS may then translate the service flow information into application information and notify the user/application by sending a DL data request message 712 containing the application information. The user/application may decide whether to accept or reject the data request and indicate the decision by sending a DL Data Response message 714 to the MS.

The MS may indicate to the BS, whether the pending DL data is accepted or rejected via a RNG-REQ message 716 with the format illustrated in FIG. 6. The BS may transmit a Paging Response message 718 to the ASN-GW, to indicate acceptance or rejection of pending DL data as indicated by the MS. If the MS rejects the DL data, the ASN-GW may drop the incoming data. If the MS accepts the DL data, service flow may be restored and data transmission may resume. The BS may then acknowledge the RNG-REQ message 716 by transmitting a Ranging Response (RNG-RSP) message 720 to the MS.

Conventional MOB_PAG-ADV messages broadcasted by a BS may not contain service flow information. Instead, the first Internet Protocol (IP) packet (or first few IP packets) from the pending DL data may carry important information such as a Session Initiation Protocol (SIP) signaling message. Certain embodiments of the present disclosure propose a technique to include the first IP packet (or the first few IP packets) in a Data TLV in a ranging response message. Therefore, an MS may decide to accept or reject pending DL data based on the information in the Data TLV.

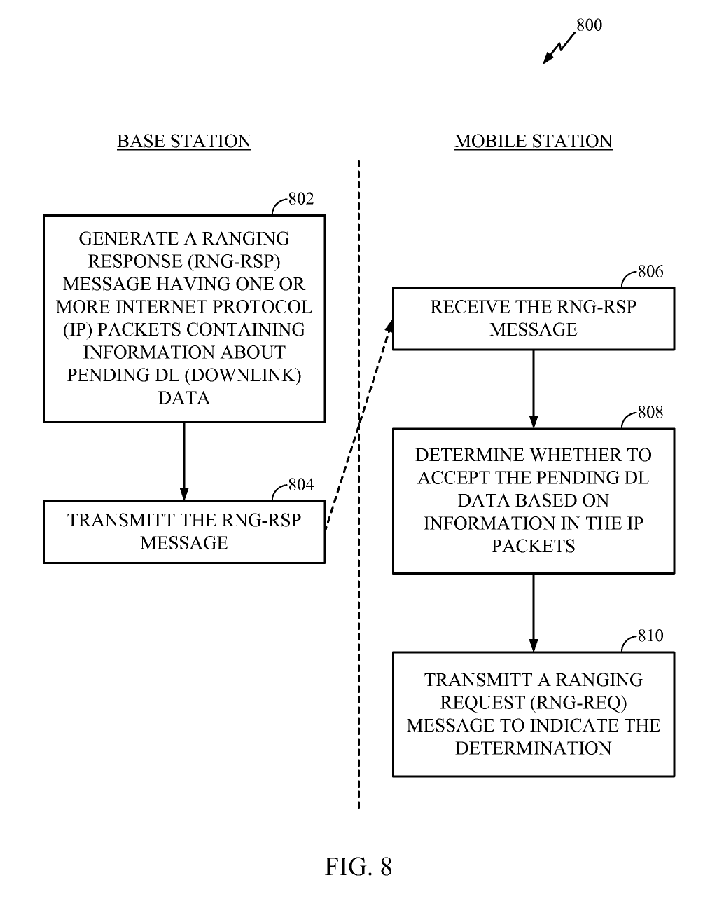

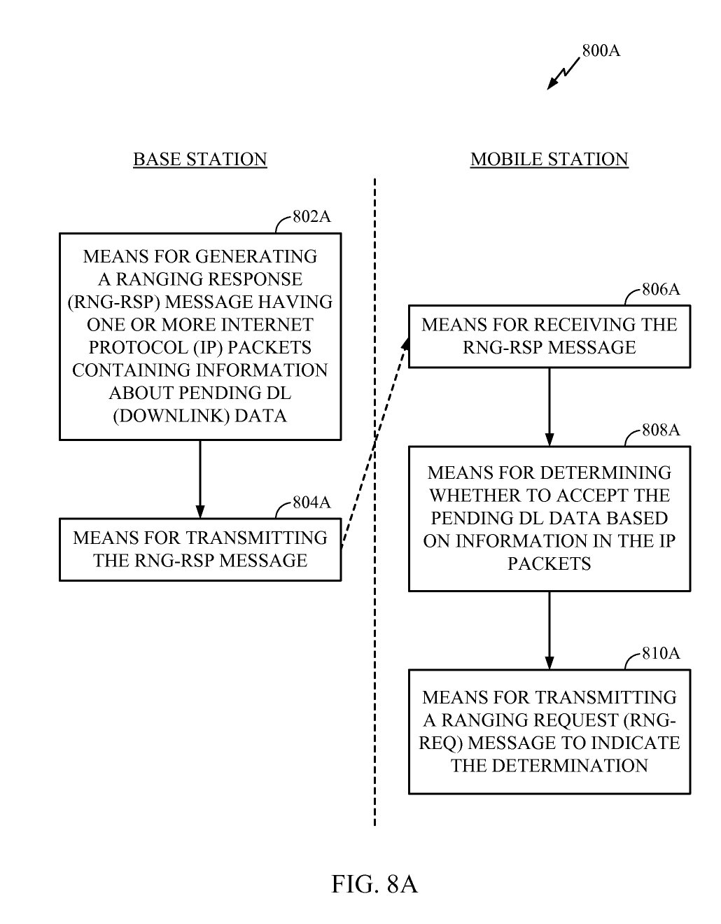

FIG. 8 illustrates example operations 800 for an alternate approach in selectively rejecting DL data in idle mode, in accordance with certain embodiments of the present disclosure. As illustrated, operations 802-804 may be performed by a BS, while operations 806-810 may be performed by an MS.

At 802, the BS may generate a Ranging Response (RNG-RSP) message with one or more IP packets containing information about pending DL data. At 804, the BS may transmit the RNG-RSP message to an MS. At 806, the MS may receive the RNG-RSP message. At 808, the MS may determine whether to accept the pending DL data based on the information in the Data TLV (e.g., IP packets) included in the RNG-RSP message.

At 810, the MS may transmit a RNG-REQ message to indicate the determination. The RNG-REQ message may utilize the format illustrated in FIG. 6. Accordingly, an enhanced Ranging Purpose Indication TLV of the RNG-REQ message may be used to indicate the determination.

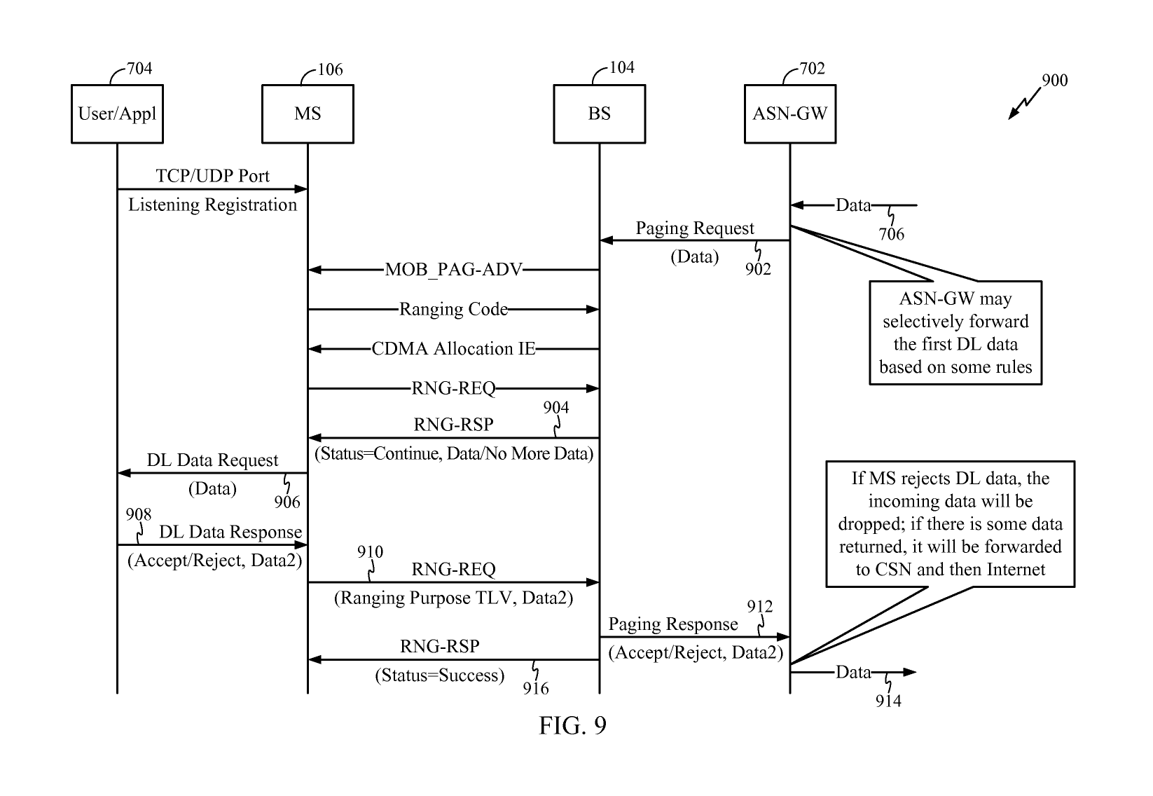

FIG. 9 illustrates an example message exchange, corresponding to the operations 800 illustrated in FIG. 8, for the alternate approach for selectively rejecting DL data in idle mode. After receiving incoming data 706, the ASN-GW may forward the first IP data packet (or the first few IP packets) contained in the received data to the BS. The IP packet(s) may be transmitted as part of a Paging Request message 902.

In certain embodiments, instead of simply forwarding the IP packet(s), the ASN-GW may establish certain rules, such as some special transmission control protocol/user datagram protocol (TCP/UDP) port number(s), before the IP packet(s) may be sent to the MS via an RNG-RSP message. For example, if port number involves a session initiation protocol (SIP), the ASN-GW may forward the packet(s) to the MS. For certain embodiments, a user/application may also register for TCP/UDP port number(s) to listen to the corresponding IP packets if ASN-GW does not have an accurate filter function as described above.

The Paging Request 902 may be followed by transmission of a MOB_PAG-ADV message. The BS and the MS may then perform a ranging procedure. After the ranging procedure, the BS may send a RNG-RSP message 904 to the MS. The RNG-RSP message may include a Data TLV comprising the IP packet(s) received from the ASN-GW. For certain embodiments, the BS may set a Ranging Status field in the RNG-RSP message as “Continue” to notify the MS to send a reply message (RNG-REQ) indicating acceptance or rejection of the pending DL data.

The MS may send a DL Data Request message 906 to the user/application 704 including the Data TLV, from which, the user/application decides whether or not to accept the pending DL data. The user/application may send a DL Data Response message 908 to the MS, indicating the acceptance or rejection of the pending DL data.

The MS may then send a RNG-REQ message 910 with the format illustrated in FIG. 6 to the BS, indicating acceptance or rejection of the pending DL data. As described earlier, the Ranging Purpose Indication TLV of the RNG-REQ message may be used for this purpose.

In an effort to inform the other side in the Internet about acceptance or rejection of continuous data, the MS may send a reply for some IP data packets, such as a SIP signaling message for rejecting or putting a session request on hold. According to certain embodiments, a Data TLV may also be included in the RNG-REQ message 910 to show the response for the IP data packets.

The BS may send a Paging Response message 912 to the ASN-GW indicating acceptance or rejection of the pending DL data by the MS. The Paging Response message may also include the Data TLV sent from the user/application and the MS. If the MS rejects pending DL data, incoming data may be dropped by the ASN-GW. If the Paging Response message contains some data returned from the MS, the data may be forwarded to a Connectivity Service Network (CSN) and then to Internet at 914. At 916, the BS may send a RNG-RSP message to acknowledge the RNG-REQ message sent by the MS with the status field set to success.

Embodiments of the present disclosure proposed methods for selectively rejecting the incoming data by a mobile station while in idle mode. The proposed methods may reject the incoming data efficiently without establishing a service flow.

It should be noted that while the proposed methods are described for communications between a base station and a mobile station, one skilled in the art may apply the proposed methods to any communication scheme between two or more devices without departing from the scope of this diclosure.

The various operations of methods described above may be performed by various hardware and/or software component(s) and/or module(s) corresponding to means-plus-function blocks illustrated in the Figures. Generally, where there are methods illustrated in Figures having corresponding counterpart means-plus-function Figures, the operation blocks correspond to means-plus-function blocks with similar numbering. For example, blocks 402-410 and 802-810 illustrated in FIGS. 4 and 8 correspond to means-plus-function blocks 402A-410A and 802A-810A illustrated in FIGS. 4A and 8A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the present disclosure may be embodied directly in hardware, or in a software module executed by a processor or in a combination of the two. A software module may reside in any form of storage medium or memory device that is known in the art. Some examples of storage media or devices that may be used include RAM memory, flash memory, ROM memory, EPROM memory, EEPROM memory, registers, a hard disk, a removable disk, a CD-ROM or other magnetic, optic, organic or quantum storage devices, and so forth. A software module may comprise a single instruction, or many instructions, and may be distributed over several different code segments, among different programs and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium or memory device. A storage media or storage device may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein, such as those illustrated in the Figures, can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to embodiments of the present disclosure, other and further embodiments of the disclosure may be devised without departing from the basic scope thereof, and the scope thereof is determined by the claims that follow.

What is claimed is:

1. A method for wireless communications, comprising:
determining downlink (DL) data pending on a network addressed to a mobile station;
generating a medium access control (MAC) message indicating information about the pending DL data;
transmitting the MAC message to the mobile station; and
receiving a notification about the pending DL data from the mobile station, wherein the notification indicates acceptance or rejection of the pending DL data.

2. The method of claim 1, wherein the MAC message comprises a paging advertisement (MOB_PAG-ADV) message, and the information about the pending DL data comprises one or more service flows of the pending DL data.

3. The method of claim 2, wherein the MOB_PAG-ADV message comprises one or more service flow bitmaps of the pending DL data, wherein each service flow bitmap comprises one or more bits, and wherein each of the bits indicates whether or not the pending DL data is associated with one of the service flows.

4. The method of claim 3, wherein the MOB_PAG-ADV message comprises at least one flag indicating that the message contains the one or more service flow bitmaps.

5. The method of claim 1, further comprising:
informing the network to drop the pending DL data if the notification indicates that the pending DL data was rejected.

6. The method of claim 1, wherein the notification comprises a ranging request (RNG-REQ) message having a bit in a Ranging Purpose Indication field to indicate the acceptance or rejection.

7. The method of claim 1, wherein the MAC message comprises a ranging response (RNG-RSP) message, wherein the DL data comprises one or more internet protocol (IP) packets and the information about the pending DL data comprises at least one of the IP packets of the pending DL data.

8. The method of claim 7, further comprising:
setting a Ranging Status field of the RNG-RSP message as Continue.

9. The method of claim 7, wherein the at least one of the IP packets comprises the first one or more IP packets of the pending DL data.

10. The method of claim 9, wherein the first one or more IP packets of the pending DL data comprise at least one session initiation protocol (SIP) signaling message.

11. A method for wireless communications, comprising:
receiving a first medium access control (MAC) message comprising information about pending downlink (DL) data;
determining whether to accept or reject the pending DL data based on the information indicated by the first MAC message; and
transmitting a second MAC message to indicate the determination.

12. The method of claim 11, wherein the first MAC message comprises a paging advertisement (MOB_PAG-ADV) message and the information about the pending DL data comprises information about one or more service flows of the pending DL data.

13. The method of claim 12, wherein the MOB_PAG-ADV message comprises one or more service flow bitmaps of the pending DL data, wherein each service flow bitmap comprises one or more bits, and wherein each of the bits indicates whether or not the pending DL data is associated with one of the service flows.

14. The method of claim 13, wherein determining whether to accept or reject the pending DL data comprises:
decoding the one or more service flow bitmaps; and
identifying at least one service flows with pending DL data based on the decoded service flow bitmaps.

15. The method of claim 11, wherein the second MAC message comprises a ranging request (RNG-REQ) message, and wherein the RNG-REQ message comprises a bit in a Ranging Purpose Indication field to indicate the determination.

16. The method of claim 11, wherein the second MAC message comprises a ranging request (RNG-REQ) message, wherein the RNG-REQ message comprises one or more internet protocol (IP) packets, wherein the IP packets are used to accept or reject one or more service flows of the pending DL data.

17. The method of claim 11, wherein the first MAC message comprises a ranging response (RNG-RSP) message, and the information about the pending DL data comprises one or more internet protocol (IP) packets of the pending DL data.

18. The method of claim 17, wherein the RNG-RSP message comprises a Ranging Status field set as Continue.

19. The method of claim 17, wherein the IP packets of the pending DL data comprise at least one session initiation protocol (SIP) signaling message, and determining whether to accept or reject the pending DL data comprises using the SIP signaling message.

20. An apparatus for wireless communications, comprising:
means for determining downlink (DL) data pending on a network addressed to a mobile station;
means for generating a medium access control (MAC) message indicating information about the pending DL data;
means for transmitting the MAC message to the mobile station; and
means for receiving a notification about the pending DL data from the mobile station, wherein the notification indicates acceptance or rejection of the pending DL data.

21. The apparatus of claim 20, wherein the MAC message comprises a paging advertisement (MOB_PAG-ADV) message, and the information about the pending DL data comprises one or more service flows of the pending DL data.

22. The apparatus of claim 21, wherein the MOB_PAG-ADV message comprises one or more service flow bitmaps of the pending DL data, wherein each service flow bitmap comprises one or more bits, and wherein each of the bits indicates whether or not the pending DL data is associated with one of the service flows.

23. The apparatus of claim 22, wherein the MOB_PAG-ADV message comprises at least one flag indicating that the message contains the one or more service flow bitmaps.

24. The apparatus of claim 20, further comprising:
means for informing the network to drop the pending DL data if the notification indicates that the pending DL data was rejected.

25. The apparatus of claim 20, wherein the notification comprises a ranging request (RNG-REQ) message having a bit in a Ranging Purpose Indication field to indicate the acceptance or rejection.

26. The apparatus of claim 20, wherein the MAC message comprises a ranging response (RNG-RSP) message, wherein the DL data comprises one or more internet protocol (IP) packets and the information about the pending DL data comprises at least one of the IP packets of the pending DL data.

27. The apparatus of claim 26, further comprising:
means for setting a Ranging Status field of the RNG-RSP message as Continue.

28. The apparatus of claim 26, wherein the at least one of the IP packets comprises the first one or more IP packets of the pending DL data.

29. The apparatus of claim 28, wherein the first one or more IP packets of the pending DL data comprise at least one session initiation protocol (SIP) signaling message.

30. An apparatus for wireless communications, comprising:
means for receiving a first medium access control (MAC) message comprising information about pending downlink (DL) data;
means for determining whether to accept or reject the pending DL data based on the information indicated by the first MAC message; and
means for transmitting a second MAC message to indicate the determination.

31. The apparatus of claim 30, wherein the first MAC message comprises a paging advertisement (MOB_PAG-ADV) message and the information about the pending DL data comprises information about one or more service flows of the pending DL data.

32. The apparatus of claim 31, wherein the MOB_PAG-ADV message comprises one or more service flow bitmaps of the pending DL data, wherein each service flow bitmap comprises one or more bits, and wherein each of the bits indicates whether or not the pending DL data is associated with one of the service flows.

33. The apparatus of claim 32, wherein the means for determining whether to accept or reject the pending DL data comprises:
means for decoding the one or more service flow bitmaps; and
means for identifying at least one service flows with pending DL data based on the decoded service flow bitmaps.

34. The apparatus of claim 30, wherein the second MAC message comprises a ranging request (RNG-REQ) message, and wherein the RNG-REQ message comprises a bit in a Ranging Purpose Indication field to indicate the determination.

35. The apparatus of claim 30, wherein the second MAC message comprises a ranging request (RNG-REQ) message, wherein the RNG-REQ message comprises one or more internet protocol (IP) packets, wherein the IP packets are used to accept or reject one or more service flows of the pending DL data.

36. The apparatus of claim 30, wherein the first MAC message comprises a ranging response (RNG-RSP) message, and the information about the pending DL data comprises one or more internet protocol (IP) packets of the pending DL data.

37. The apparatus of claim 36, wherein the RNG-RSP message comprises a Ranging Status field set as Continue.

38. The apparatus of claim 36, wherein the IP packets of the pending DL data comprise at least one session initiation protocol (SIP) signaling message, and determining whether to accept or reject the pending DL data comprises using the SIP signaling message.

39. An apparatus for wireless communications, comprising:
logic for determining downlink (DL) data pending on a network addressed to a mobile station;
logic for generating a medium access control (MAC) message indicating information about the pending DL data;
logic for transmitting the MAC message to the mobile station; and
logic for receiving a notification about the pending DL data from the mobile station, wherein the notification indicates acceptance or rejection of the pending DL data.

40. The apparatus of claim 39, wherein the MAC message comprises a paging advertisement (MOB_PAG-ADV) message, and the information about the pending DL data comprises one or more service flows of the pending DL data.

41. The apparatus of claim 40, wherein the MOB_PAG-ADV message comprises one or more service flow bitmaps of the pending DL data, wherein each service flow bitmap comprises one or more bits, and wherein each of the bits indicates whether or not the pending DL data is associated with one of the service flows.

42. The apparatus of claim 41, wherein the MOB_PAG-ADV message comprises at least one flag indicating that the message contains the one or more service flow bitmaps.

43. The apparatus of claim 39, further comprising:
logic for informing the network to drop the pending DL data if the notification indicates that the pending DL data was rejected.

44. The apparatus of claim 39, wherein the notification comprises a ranging request (RNG-REQ) message having a bit in a Ranging Purpose Indication field to indicate the acceptance or rejection.

45. The apparatus of claim 39, wherein the MAC message comprises a ranging response (RNG-RSP) message, wherein the DL data comprises one or more internet protocol (IP) packets and the information about the pending DL data comprises at least one of the IP packets of the pending DL data.

46. The apparatus of claim 45, further comprising:
logic for setting a Ranging Status field of the RNG-RSP message as Continue.

47. The apparatus of claim 45, wherein the at least one of the IP packets comprises the first one or more IP packets of the pending DL data.

48. The apparatus of claim 47, wherein the first one or more IP packets of the pending DL data comprise at least one session initiation protocol (SIP) signaling message.

49. An apparatus for wireless communications, comprising:
logic for receiving a first medium access control (MAC) message comprising information about pending downlink (DL) data;
logic for determining whether to accept or reject the pending DL data based on the information indicated by the first MAC message; and
logic for transmitting a second MAC message to indicate the determination.

50. The apparatus of claim 49, wherein the first MAC message comprises a paging advertisement (MOB_PAG-ADV) message and the information about the pending DL data comprises information about one or more service flows of the pending DL data.

51. The apparatus of claim 50, wherein the MOB_PAG-ADV message comprises one or more service flow bitmaps of the pending DL data, wherein each service flow bitmap comprises one or more bits, and wherein each of the bits indicates whether or not the pending DL data is associated with one of the service flows.

52. The apparatus of claim 51, wherein the logic for determining whether to accept or reject the pending DL data comprises:
logic for decoding the one or more service flow bitmaps; and
logic for identifying at least one service flows with pending DL data based on the decoded service flow bitmaps.

53. The apparatus of claim 49, wherein the second MAC message comprises a ranging request (RNG-REQ) message, and wherein the RNG-REQ message comprises a bit in a Ranging Purpose Indication field to indicate the determination.

54. The apparatus of claim 49, wherein the second MAC message comprises a ranging request (RNG-REQ) message, wherein the RNG-REQ message comprises one or more internet protocol (IP) packets, wherein the IP packets are used to accept or reject one or more service flows of the pending DL data.

55. The apparatus of claim 49, wherein the first MAC message comprises a ranging response (RNG-RSP) message, and the information about the pending DL data comprises one or more internet protocol (IP) packets of the pending DL data.

56. The apparatus of claim 55, wherein the RNG-RSP message comprises a Ranging Status field set as Continue.

57. The apparatus of claim 55, wherein the IP packets of the pending DL data comprise at least one session initiation protocol (SIP) signaling message, and determining whether to accept or reject the pending DL data comprises using the SIP signaling message.

58. A computer-program storage apparatus for wireless communications, comprising a memory device having instructions stored thereon, the instructions being executable by one or more processors and the instructions comprising:
instructions for determining downlink (DL) data pending on a network addressed to a mobile station;
instructions for generating a medium access control (MAC) message indicating information about the pending DL data;
instructions for transmitting the MAC message to the mobile station; and
instructions for receiving a notification about the pending DL data from the mobile station, wherein the notification indicates acceptance or rejection of the pending DL data.

59. The computer-program storage apparatus of claim 58, wherein the MAC message comprises a paging advertisement (MOB_PAG-ADV) message, and the information about the pending DL data comprises one or more service flows of the pending DL data.

60. The computer-program storage apparatus of claim 59, wherein the MOB_PAG-ADV message comprises one or more service flow bitmaps of the pending DL data, wherein each service flow bitmap comprises one or more bits, and wherein each of the bits indicates whether or not the pending DL data is associated with one of the service flows.

61. The computer-program storage apparatus of claim 60, wherein the MOB_PAG-ADV message comprises at least one flag indicating that the message contains the one or more service flow bitmaps.

62. The computer-program storage apparatus of claim 58, further comprising:
instructions for informing the network to drop the pending DL data if the notification indicates that the pending DL data was rejected.

63. The computer-program storage apparatus of claim 58, wherein the notification comprises a ranging request (RNG-REQ) message having a bit in a Ranging Purpose Indication field to indicate the acceptance or rejection.

64. The computer-program storage apparatus of claim 58, wherein the MAC message comprises a ranging response (RNG-RSP) message, wherein the DL data comprises one or more internet protocol (IP) packets and the information about the pending DL data comprises at least one of the IP packets of the pending DL data.

65. The computer-program storage apparatus of claim 64, further comprising:
instructions for setting a Ranging Status field of the RNG-RSP message as Continue.

66. The computer-program storage apparatus of claim 64, wherein the at least one of the IP packets comprises the first one or more IP packets of the pending DL data.

67. The computer-program storage apparatus of claim 66, wherein the first one or more IP packets of the pending DL data comprise at least one session initiation protocol (SIP) signaling message.

68. A computer-program storage apparatus for wireless communications, comprising a memory device having instructions stored thereon, the instructions being executable by one or more processors and the instructions comprising:
instructions for receiving a first medium access control (MAC) message comprising information about pending downlink (DL) data;
instructions for determining whether to accept or reject the pending DL data based on the information indicated by the first MAC message; and
instructions for transmitting a second MAC message to indicate the determination.

69. The computer-program storage apparatus of claim 68, wherein the first MAC message comprises a paging advertisement (MOB_PAG-ADV) message and the information about the pending DL data comprises information about one or more service flows of the pending DL data.

70. The computer-program storage apparatus of claim 69, wherein the MOB_PAG-ADV message comprises one or more service flow bitmaps of the pending DL data, wherein each service flow bitmap comprises one or more bits, and wherein each of the bits indicates whether or not the pending DL data is associated with one of the service flows.

71. The computer-program storage apparatus of claim 70, wherein the instructions for determining whether to accept or reject the pending DL data comprise:
instructions for decoding the one or more service flow bitmaps; and
instructions for identifying at least one service flows with pending DL data based on the decoded service flow bitmaps.

72. The computer-program storage apparatus of claim 68, wherein the second MAC message comprises a ranging request (RNG-REQ) message, and wherein the RNG-REQ message comprises a bit in a Ranging Purpose Indication field to indicate the determination.

73. The computer-program storage apparatus of claim 68, wherein the second MAC message comprises a ranging request (RNG-REQ) message, wherein the RNG-REQ message comprises one or more internet protocol (IP) packets, wherein the IP packets are used to accept or reject one or more service flows of the pending DL data.

74. The computer-program storage apparatus of claim 68, wherein the first MAC message comprises a ranging response (RNG-RSP) message, and the information about the pending DL data comprises one or more internet protocol (IP) packets of the pending DL data.

75. The computer-program storage apparatus of claim 74, wherein the RNG-RSP message comprises a Ranging Status field set as Continue.

76. The computer-program storage apparatus of claim 74, wherein the IP packets of the pending DL data comprise at least one session initiation protocol (SIP) signaling message, and determining whether to accept or reject the pending DL data comprises using the SIP signaling message.
